(19) United States
(12) Patent Application Publication
(10) Pub. No.: US 2005/0137266 A1
(43) Pub. Date: Jun. 23, 2005

(54) Aqueous composition of an oligomeric fluorosilane and use thereof for surface treatment of optical elements

(76) Inventors: Naiyong Jing, Woodbury, MN (US); Zai-Ming Qiu, Woodbury, MN (US)

Correspondence Address: 3M INNOVATIVE PROPERTIES COMPANY, PO BOX 33427, ST. PAUL, MN, 55133-3427, US

(21) Appl. No.: 10/745,004

(22) Filed: Dec. 23, 2003

(51) Int. Cl. B01F 17/54

(52) U.S. Cl. 516/53

(57) ABSTRACT

The present invention relates to an aqueous composition comprising an oligomeric fluorosilane and a surfactant. The invention further relates to a method of treatment of optical elements with the aqueous composition and to optical elements so treated. The invention further relates to articles including the treated optical elements.

### FIELD

The present invention relates to an aqueous composition comprising an oligomeric fluorosilane and a surfactant. The invention further relates to a method of treatment of optical elements with the aqueous composition and to optical elements so treated. The invention further relates to articles including the treated optical elements.

### BACKGROUND

Beaded projection display screens, retroreflective sheeting used in the manufacture of roadway signs, and retroreflective paints typically include optical elements adhered through the use of a binder. In the case of beaded projection display materials, the optical elements are microscopic glass beads that act as lenses to collect projected light from the rear of the screen and focus it to relatively small spots, near the surfaces of the microspheres. The foci are approximately in the areas where the optical elements contact a front support layer. In other retroreflective materials, the optical elements act as lenses which focus the light onto a reflector (metal mirror of diffusely reflecting pigment) and once the light has been reflected off the reflector the microspheres again act as lenses to resend the light back toward the incoming light source. In order to contribute the desired retroreflective property, however, it is important that a layer of glass microspheres be present on the surface of the binder layer.

As discussed in U.S. Pat. No. 3,222,204, ordinary glass beads tend to sink into the uncured liquid binder layer. In instances wherein the individual beads are not entirely submerged, the optical properties of the bead can also be impaired by the binder wetting out the bead surface and spreading on the exposed bead surface. To address this problem, U.S. Pat. No. 3,222,204 disclosed coating the glass beads with a thin surface coating of an oleophobic fluorocarbon-sizing agent. At column 5, lines 61-75, this reference states that, “Aqueous treating solutions of fluorocarbon chromium coordination complexes are preferred and are described in U.S. Pat. Nos. 2,662,835 (Dec. 15, 1953), U.S. Pat. No. 2,809,990 (Oct. 15, 1957), and U.S. Pat. No. 2,934,450 (Apr. 26, 1960). The complex may be made by reacting chromyl chloride with a fluorocarbon monocarboxylic acid (having a highly fluorinated terminal chain or tail containing 4 to 10 carbon atoms) in an isopropanol vehicle that serves as both a solvent and reducing agent, the chromium to acid mole ratio being in the range of 2:1 to 5:1. The resultant green-colored isopropanol solution of the complex is diluted with water at the time of use. The fluorocarbon acid preferably has 6 to 8 fully fluorinated (perfluorinated) carbon atoms in the terminal fluorocarbon chain or tail.” Specific working examples include chromium coordination complexes of perfluorooctanoic acid and N-ethyl-N-perfluorooctanesulfonyl glycine.

U.S. Pat. No. 4,713,295 disclosed coating glass beads with a mixture of substances. The mixture comprises a first substance which if used alone would tend to make the beads hydrophobic while leaving them oleophilic and a second substance which if used alone would tend to make the beads both hydrophobic and oleophobic. “For the best results, it is preferred to use a second substance which is an anionic fluorocarbon compound, and optimally, said second substance is a fluoro-alkyl-sulphonate, for example a fluoro-alkyl-sulphonate in which the alkyl has a long chain (C₁₄ to C₁₈).” (See Column 4, lines 8-13). The exemplified hydrophobic and oleophobic substance is a potassium fluoroalkyl-sulphonate (for example FC129 from 3M Company). (See column 5, lines 50-52) FC129 is a potassium fluoroctyl sulphonyl-containing compound.

U.S. Publication No. 2002/0090515 and WO 02/68353 disclose the use of perfluoropolyether compounds for the treatment of optical elements. In particular, compounds of the formula R_{f}-X are taught wherein R_{f} represents a perfluoropolyether group and X represents a polar group including for example acid groups as well as silane groups.

U.S. Pat. No. 6,582,759 disclosed a reaction product of (i) non-fluorinated polyol, (ii) a fluorinated monoalcohol and (iii) at least one of a polyisocyanate, a polycarboxylic acid and a polyphosphoric acid for the treatment of optical elements. In one embodiment, the reaction product also includes a silane group.

Despite the many known fluorochemical compositions for the treatment of optical elements, there continues to be a need to find further suitable compositions. Desirably, such composition is environmentally benign and can be produced in a convenient, easy and cost effective. Desirably, the composition is capable of providing floatation to the optical elements in an effective way. Desirably the compositions have a good storage stability.

### SUMMARY

In one aspect, the invention provides an aqueous composition that comprises a surfactant and a fluorosilane according to the general formula:
X-M^{f}ₙM^{h}ₘM^{a}ᵣ-G (I)
wherein X represents the residue of an initiator or hydrogen;
M^{f} represents units derived from one or more fluorinated monomer;
M^{h} represents units derived from one or more non-fluorinated monomer;
M^{a} represents units having a silyl group represented by the formula: 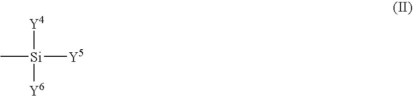
   wherein each of Y⁴, Y⁵ and Y⁶ independently represents an alkyl group, an aryl group and at least one of Y⁴, Y⁵ and Y⁶ represents a hydrolyzable group selected from the group consisting of halogens, alkoxy groups, acyloxy groups, acyl groups and aryloxy groups;
G is a monovalent organic group comprising the residue of a chain transfer agent;
n represents a value of 1 to 100;
m represents a value of 0 to 100;
and r represents a value of 0 to 100;
and n+m+r is at least 2;
with the proviso that at least one of the following conditions is fulfilled: (a) G contains a silyl group of the formula: 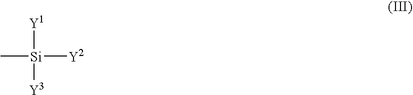
   wherein Y¹, Y² and Y³ each independently represents an alkyl group, an aryl group or a hydrolyzable group and at least one of Y¹, Y² and Y³ represents a hydrolyzable group selected from the group consisting of halogens, alkoxy groups, acyloxy groups, acyl groups and aryloxy groups; or (b) r is at least 1.

The aqueous composition can be used to treat the surface of optical elements and to provide floatation to the optical elements. The composition typically provides the advantage of effectively providing floatation. Generally, the aqueous composition has a good storage stability and can be designed in an environmental friendly way.

In another aspect, the invention provides a method of treating optical elements with the aqueous composition and to optical elements so treated.

The invention further relates to reflective articles such as pavement markings, reflective sheeting, and projection screens comprising a binder and the surface treated optical elements of the invention. The optical elements are generally embedded in the binder surface at a depth of about 40 to 80 percent of their diameters, preferably 40 to 60 percent.

### DETAILED DESCRIPTION

Aqueous Composition

The fluorosilanes, also called fluorochemical silanes hereinafter, corresponding to the general formula I, are generally oligomers that can be prepared by free-radical oligomerization of a fluorochemical monomer and optionally a non-fluorinated monomer in the presence of a chain transfer agent. The oligomers should also include one or more silyl groups that have one or more hydrolyzable groups. Hydrolyzable groups include halogens such as e.g., chlorine or bromine, alkoxy groups including for example C₁ to C₄ alkoxy groups such as methoxy, ethoxy or propoxy groups, acyloxy groups, acyl groups and aryloxy groups. The silyl groups having one or more hydrolysable groups can be included in the fluorochemical silane by copolymerizing the fluorochemical monomer with a silyl group-containing monomer or through the use of chain transfer agent that includes a silyl group. Alternatively, a functionalized chain transfer agent or functionalized comonomer can be used which can be reacted with a silyl group containing reagent subsequent to the oligomerization.

The total number of units in the oligomer is represented by the sum of n, m and r and is generally at least 2 and preferably at least 3 so as to render the compound oligomeric. The value of n in the fluorochemical oligomer is typically between 1 and 100 and preferably between 2 and 20. The values of m and r are typically between 0 and 100 and preferably between 1 and 30. According to a preferred embodiment, the value of m is less than that of n and n+m+r is at least 2. The molecular weight of the fluorochemical oligomers is typically between about 400 and 100000, preferably between 800 and 20000.

It will further be appreciated by one skilled in the art that the preparation of fluorochemical silanes according to the present invention may result in a mixture of compounds and accordingly, the general formula (I) should be understood as representing a mixture of compounds whereby the indices n, m and r in formula I represent the molar amount of the corresponding unit in the mixture. Accordingly, it will be clear that n, m and r can be fractional values.

The units M^{f} of the fluorochemical silane are generally derived from fluorochemical monomers corresponding to the formula:
R_{f}-Q-E¹ (IV)
wherein R_{f} represents a fluoroaliphatic group containing at least 3 carbon atoms or a fluorinated polyether group. Q represents an organic divalent linking group and E¹ represents a free radical polymerizable group.

The fluoroaliphatic group R_{f}, in the fluorochemical monomer, is a fluorinated, stable, inert, preferably saturated, non-polar, monovalent aliphatic radical. It can be straight chain, branched chain, or cyclic or combinations thereof. It can contain heteroatoms such as oxygen, divalent or hexavalent sulfur, or nitrogen. R_{f} is preferably a fully-fluorinated radical, but hydrogen or chlorine atoms can be present as substituents if not more than one atom of either is present for every two carbon atoms. The R_{f} radical typically has at least 3 and up to 18 carbon atoms, preferably 3 to 14, especially 4 to 10 carbon atoms, and preferably contains about 40% to about 80% fluorine by weight, more preferably about 50% to about 78% fluorine by weight. The terminal portion of the R_{f} radical is a perfluorinated moiety, which will preferably contain at least 7 fluorine atoms, e.g., CF₃CF₂CF₂—, (CF₃)₂CF—, F₅SCF₂—. The preferred R_{f} radicals are fully or substantially fluorinated and are preferably those perfluorinated aliphatic radicals of the formula CₙF₂ₙ₊1— where n is 3 to 18, particularly 4 to 10.

The R_{f} group can also be a perfluoropolyether group. The perfluoropolyether group R_{f} can include linear, branched, and/or cyclic structures, that may be saturated or unsaturated, and substituted with one or more oxygen atoms. It is preferably a perfluorinated group (i.e., all C—H bonds are replaced by C—F bonds). More preferably, it includes perfluorinated repeating units selected from the group of —(CₙF₂ₙ)—, —(CₙF₂ₙO)—, —(CF(Z))—, —(CF(Z)O)—, —(CF(Z)CₙF₂ₙO)—, —(CₙF₂ₙCF(Z)O)—, —(CF2CF(Z)O)—, and combinations thereof. In these repeating units Z is a perfluoroalkyl group, an oxygen-substituted perfluoroalkyl group, a perfluoroalkoxy group, or an oxygen-substituted perfluoroalkoxy group, all of which can be linear, branched, or cyclic, and preferably have about 1 to about 9 carbon atoms and 0 to about 4 oxygen atoms. The terminal groups can be (CₙF₂ₙ₊₁)—, (CₙF₂ₙ₊₁O)—or (X′CₙF₂ₙO)—, wherein X′ is H, Cl, or Br, for example. Preferably, these terminal groups are perfluorinated. In these repeating units or terminal groups, n is 1 or more, and preferably about 1 to about 4. Particularly preferred approximate average structures for a perfluoropolyether group include C₃F₇O(CF(CF₃)CF₂O)ₚCF(CF₃)— and CF₃O(C₂F₄O)ₚCF₂— wherein an average value for p is 1 to about 50. As synthesized, these compounds typically include a mixture of polymers. The approximate average structure is the approximate average of the mixture of polymers.

Difunctional fluorochemical monomers can also be used provided the resulting fluorochemical silane remains dispersible in the aqueous medium at least at 0.1% by weight. Accordingly, M^{f} in formula I can further be derived from a difunctional fluorochemical monomer corresponding to the formula:
Ea-Qa-R¹_{f}Q^{b}-E^{b} (V)
wherein Q^{a} and Q^{b} each independently represents an organic divalent linking group and E^{a} and E^{b} each independently represent a free radical polymerizable group. R¹_{f} represents a divalent perfluoropolyether group such as, for example, —(CF(CF₃)CF₂-O)ₚ—, —(CF₂O)ₚ(CF₂CF₂O)_{q}—, —CF(CF₃)(CF₂CF(CF₃)O)ₚCF(CF₃)O—, —(CF₂O)ₚ(CF₂CF₂O)_{q}CF₂—, —(CF₂CF₂O)ₚ—, —(CF₂CF₂CF₂O)ₚ—, wherein an average value for p and q is 1 to about 50. The molecular weight of the difunctional fluorochemical monomer should generally be between about 200 and 1000, more preferably between 300 and 600.

The linking groups Q, Q^{a} and Q^{b} in the above formulas (IV) and (V) link the fluoroaliphatic or the fluorinated polyether group R_{f} or R¹_{f} to the free radical polymerizable group E¹, E^{a} or E^{b} and are generally non-fluorinated organic linking groups. The linking groups preferably contain from 1 to about 20 carbon atoms and may optionally contain oxygen, nitrogen, or sulfur-containing groups or a combination thereof. The linking groups are preferably free of functional groups that substantially interfere with free-radical oligomerization (e.g., polymerizable olefinic double bonds, thiols, and other such functionality known to those skilled in the art). Illustrative examples of suitable linking groups include straight chain, branched chain or cyclic alkylene, arylene, aralkylene, oxy, oxo, hydroxy, thio, sulfonyl, sulfoxy, amino, imino, sulfonamido, carboxamido, carbonyloxy, urethanylene, ureylene, and combinations thereof such as sulfonamidoalkylene. Preferred linking groups are selected from the group consisting of alkylene and an organic divalent linking group according to the following formulae: 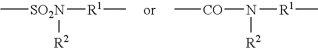
wherein R¹ represents a hydrogen or a linear or branched alkylene having 2 to 4 carbon atoms and R² represents a hydrogen or an alkyl having 1 to 4 carbon atoms. E¹, E^{a} and E^{b} are a free radically polymerizable groups that typically contain an ethylenically unsaturated group capable of undergoing a free radical polymerization. Suitable groups include, for example, moieties derived from vinyl ethers, vinyl esters, allyl esters, vinyl ketones, styrene, vinyl amide, acrylamides, maleates, fumarates, acrylates and methacrylates. Of these, the esters of alpha, beta unsaturated acids, such as the acrylates and methacrylates are preferred.

Fluorochemical monomers R_{f}-Q-E¹ as described above and methods for the preparation thereof are known and disclosed, e.g., in U.S. Pat. No. 2,803,615. Illustrative examples of such compounds include general classes of fluorochemical acrylates, methacrylates, vinyl ethers, and allyl compounds containing fluorinated sulfonamido groups, acrylates or methacrylates derived from fluorochemical telomer alcohols, acrylates or methacrylates derived from fluorochemical carboxylic acids, and perfluoroalkyl acrylates or methacrylates as disclosed in EP-A-526 976. Fluorinated polyetheracrylates or methacrylates suitable for use herein are described in U.S. Pat. No. 4,085,137.

Examples of fluorochemical monomers include: 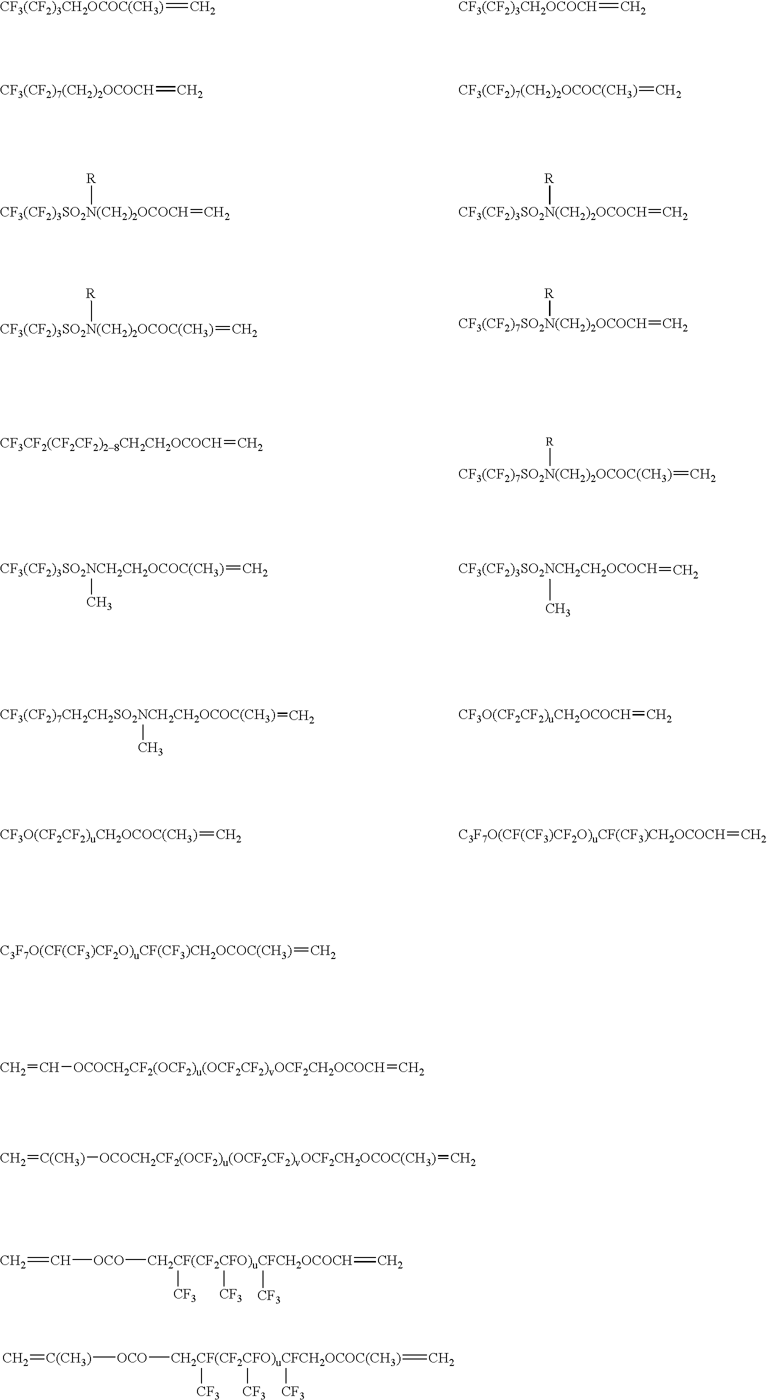
wherein R represents methyl, ethyl or n-butyl and u and v are about 1 to 50.

The units M^{h} (when present) of the fluorochemical silane are generally derived from a non-fluorinated monomer, preferably a monomer consisting of a polymerizable group and a hydrocarbon moiety. Hydrocarbon group containing monomers are well known and generally commercially available. Illustrative examples of non-fluorinated monomers from which units M^{h} can be derived include general classes of ethylenic compounds capable of free-radical polymerization, such as, for example, allyl esters such as allyl acetate and allyl heptanoate; alkyl vinyl ethers or alkyl allyl ethers such as cetyl vinyl ether, dodecylvinyl ether, 2-chloroethylvinyl ether, ethylvinyl ether; unsaturated acids such as acrylic acid, methacrylic acid, alpha-chloro acrylic acid, crotonic acid, maleic acid, fumaric acid, itaconic acid and their anhydrides and their esters such as vinyl, allyl, methyl, butyl, isobutyl, hexyl, heptyl, 2-ethylhexyl, cyclohexyl, lauryl, stearyl, isobornyl or alkoxy ethyl acrylates and methacrylates; alpha-beta unsaturated nitriles such as acrylonitrile, methacrylonitrile, 2-chloroacrylonitrile, 2-cyanoethyl acrylate, alkyl cyanoacrylates; alpha,beta-unsaturated carboxylic acid derivatives such as allyl alcohol, allyl glycolate, acrylamide, methacrylamide, n-diisopropyl acrylamide, diacetoneacrylamide, N,N-diethylaminoethylmethacrylate, N-t-butylamino ethyl methacrylate; styrene and its derivatives such as vinyltoluene, alpha-methylstyrene, alpha-cyanomethyl styrene; lower olefinic hydrocarbons which can contain halogen such as ethylene, propylene, isobutene, 3-chloro-1-isobutene, butadiene, isoprene, chloro and dichlorobutadiene and 2,5-dimethyl-1,5-hexadiene, and allyl or vinyl halides such as vinyl and vinylidene chloride. Preferred non-fluorinated monomers include hydrocarbon group containing monomers such as those selected from octadecylmethacrylate, laurylmethacrylate, butylacrylate, N-methylol acrylamide, isobutylmethacrylate, ethylhexyl acrylate and ethylhexyl methacrylate; and vinylcloride and vinylidene chloride.

The fluorochemical silane of the invention may further include units Ma which are derivable from a monomer represented by the formula: 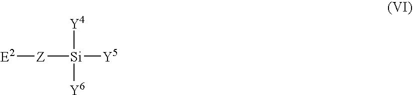
wherein each of Y⁴,Y⁵ and Y⁶ independently represents an alkyl group, an aryl group, a hydrolysable group; Z represents an organic divalent linking group and E² represents a free radical polymerizable group such as for example listed above with respect to E¹.

The organic divalent linking group Z preferably contains from 1 to about 20 carbon atoms. Z can optionally contain oxygen, nitrogen, or sulfur-containing groups or a combination thereof, and Z is preferably free of functional groups that substantially interfere with free-radical oligomerization (e.g., polymerizable olefinic double bonds, thiols, and other such functionality known to those skilled in the art). Illustrative examples of suitable linking groups Z include straight chain, branched chain or cyclic alkylene, arylene, aralkylene, oxyalkylene, carbonyloxyalkylene, oxycarboxyalkylene, carboxyamidoalkylene, urethanylenealkylene, ureylenealkylene, and combinations thereof. Preferred linking groups are selected from the group consisting of alkylene, oxyalkylene and carbonyloxyalkylene.

Y⁴,Y⁵, and Y⁶ independently represents an alkyl group, an aryl group and at least one of them is a hydrolysable group. Hydrolyzable groups include halogen, alkoxy, acyloxy, acyl or aryloxy groups.

The fluorochemical silane is conveniently prepared through a free radical polymerization of a fluorinated monomer with optionally a non-fluorinated monomer and a monomer containing a silyl group in the presence of a chain transfer agent. A free radical initiator is generally used to initiate the polymerization or oligomerization reaction. Commonly known free-radical initiators can be used and examples thereof include azo compounds, such as azobisisobutyronitrile (ABIN), azo-2-cyanovaleric acid and the like, hydroperoxides such as cumene, t-butyl and t-amyl hydroperoxide, dialkyl peroxides such as di-t-butyl and dicumylperoxide, peroxyesters such as t-butylperbenzoate and di-t-butylperoxy phthalate, diacylperoxides such as benzoyl peroxide and lauroyl peroxide.

The oligomerization reaction can be carried out in any solvent suitable for organic free-radical reactions. The reactants can be present in the solvent at any suitable concentration, e.g., from about 5 percent to about 90 percent by weight based on the total weight of the reaction mixture. Illustrative examples of suitable solvents include aliphatic and alicyclic hydrocarbons (e.g., hexane, heptane, cyclohexane), aromatic solvents (e.g., benzene, toluene, xylene), ethers (e.g., diethylether, glyme, diglyme, diisopropyl ether), esters (e.g., ethyl acetate, butyl acetate), alcohols (e.g., ethanol, isopropyl alcohol), ketones (e.g., acetone, methylethyl ketone, methyl isobutyl ketone), sulfoxides (e.g., dimethyl sulfoxide), amides (e.g., N,N-dimethylformamide, N,N-dimethylacetamide), halogenated solvents such as methylchloroform, FREON™113, trichloroethylene, α,α,α-trifluorotoluene, and the like, and mixtures thereof.

The oligomerization reaction can be carried out at any temperature suitable for conducting an organic free-radical reaction. Particular temperature and solvents for use can be easily selected by those skilled in the art based on considerations such as the solubility of reagents, the temperature required for the use of a particular initiator, molecular weight desired and the like. While it is not practical to enumerate a particular temperature suitable for all initiators and all solvents, generally suitable temperatures are between about 30° C. and about 200° C.

The fluorochemical oligomer is prepared in the presence of chain transfer agent. Suitable chain transfer agents typically include a hydroxy-, amino-, or mercapto group. The chain transfer agent may include two or more of such hydroxy, amino- or mercapto groups. Illustrative examples of typical chain transfer agents useful in the preparation of the fluorochemical oligomer include those selected from 2-mercaptoethanol, 3-mercapto-2-butanol, 3-mercapto-2-propanol, 3-mercapto-1-propanol, 3-mercapto-1,2-propanediol, 2-mercapto-ethylamine, di(2-mercaptoethyl)sulfide, octylmercaptane, dodecylmercaptane or a mercapto functionalized polysiloxane such as 3-(trimethoxysilyl)propyl mercaptan.

In a preferred embodiment a chain transfer agent containing a silyl group having one or more hydrolyzable groups is used in the oligomerization to produce the fluorochemical oligomer. Transfer agents including a silyl group include those according to formula VII. 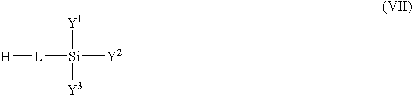
wherein Y¹, Y² and Y³ each independently represents an alkyl group, preferably a C₁-C₈ alkyl group such as methyl, ethyl or propyl or an alkyl group containing a cycloalkyl such as cyclohexyl or cylcopentyl, an aryl group such as phenyl, an alkylaryl group or an aralkyl group, a hydrolysable group such as for example halogen, alkoxy groups such as methoxy or ethoxy, acyloxy groups, acyl groups or aryloxy groups, with at least one of Y¹, Y² and Y³ representing a hydrolysable group. L represents a divalent linking group such as —O—, —S— and —NR wherein R represents an alkyl or aryl group.

Preferred chain transfer agents are those in which L represents —S-Q¹- with Q¹ being linked to the silicone atom in formula VII and wherein Q¹ represents an organic divalerit linking group such as for example a straight chain, branched chain or cyclic alkylene, arylene or aralkylene.

A single chain transfer agent or a mixture of different chain transfer agents may be used. The preferred chain transfer agents are 2-mercaptoethanol, octylmercaptane and 3-mercaptopropyltrimethoxysilane. A chain transfer agent is typically present in an amount sufficient to control the number of polymerized monomer units in the oligomer and to obtain the desired molecular weight of the oligomeric fluorochemical silane. The chain transfer agent is generally used in an amount of about 0.05 to about 0.5 equivalents, preferably about 0.25 equivalents, per equivalent of monomer including fluorinated and non-fluorinated monomers.

A further embodiment for producing the fluorochemical silane, involves the polymerisation or oligomerization of one or more fluorinated monomers and a monomer having a functional group available for subsequent reaction such as for example a hydroxy group or amino group in the presence of a chain transfer agent. Examples of such monomers include hydroxy or amino functionalized acrylate or methacrylates, such as 2-hydroxyethyl(meth)acrylate, 3-hydroxypropyl(meth)acrylate, 6-hydroxyhexyl(meth)acrylate and the like. Alternative to or in addition to the use of functionalized monomer, a functionalized chain transfer agent can be used. For example, a chain transfer agent can be used that is functionalized with a group such as a hydroxy group or an amino group. Illustrative examples of such chain transfer agents include 2-mercaptoethanol, 3-mercapto-2-butanol, 3-mercapto-2-propanol, 3-mercapto-1-propanol, 3-mercapto-1,2-propanediol and 2-mercapto-ethylamine. Subsequent to the oligomerization the functional group contained in the comonomer and/or chain transfer agent can be reacted with a compound including a silyl group having hydrolysable groups and that is capable of reacting with the functional group contained in the comonomer and/or chain transfer agent.

Suitable compounds for reacting with the functional groups present in the monomer or chain transfer agent include compounds according to the following formula: 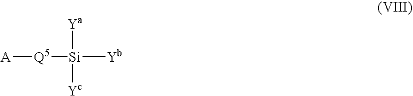
wherein A represents a functional group capable of undergoing a condensation reaction with the functional group contained in the monomer or chain transfer agent, in particular a functional group capable of condensing with a hydroxy or amino functional oligomer. Examples of A include an isocyanate or an epoxy group. Q⁵ represents an organic divalent linking group, Y^{a}, Y^{b} and Y^{c} each independently represents an alkyl group, preferably a C₁-C₈ alkyl group such as methyl, ethyl or propyl or an alkyl group containing a cycloalkyl such as cyclohexyl or cylcopentyl, an aryl group such as phenyl, an alkylaryl group or an aralkyl group or hydrolysable group such as for example halogen, an alkoxy group such as methoxy or ethoxy, an acyloxy group, an acyl group or an aryloxy group and at least one of Y^{a}, Y^{b} and Y^{c} represents a hydrolysable group. Illustrative examples of organic divalent linking groups Q⁵ include straight chain, branched chain or cyclic alkylene, arylene, aralkylene, oxyalkylene, carbonyloxyalkylene, oxycarboxyalkylene, carboxyamidoalkylene, urethanylenealkylene, ureylenealkylene and combinations thereof. Preferred linking groups are selected from the group consisting of alkylene, oxyalkylene and carbonyloxyalkylene.

Illustrative examples of compounds according to formula VIII include 3-isocyanatopropyltrimethoxysilane and 3-epoxypropyltrimethoxysilane.

The condensation reaction is conveniently carried out under conventional conditions well-known to those skilled in the art. Preferably the reaction is run in the presence of a catalyst. Illustrative examples of suitable catalysts include tin salts such as dibutyltin dilaurate, stannous octanoate, stannous oleate, tin dibutyldi-(2-ethyl hexanoate), stannous chloride; and others known to those skilled in the art. The amount of catalyst present will depend on the particular reaction, and thus it is not practical to recite particular preferred concentrations. Generally, however, suitable catalyst concentrations are from about 0.001 percent to about 10 percent, preferably about 0.1 percent to about 5 percent, by weight based on the total weight of the reactants.

The condensation reaction is preferably carried out under dry conditions in a polar solvent such as ethyl acetate, acetone, methyl isobutyl ketone, toluene and the like. Suitable reaction temperatures will be easily determined by those skilled in the art based on the particular reagents, solvents, and catalysts being used. Suitable temperatures are typically between about room temperature and about 120° C.

In case a functionalized chain transfer agent as set forth above is used in the oligomerization, the condensation reaction of the oligomer with a compound according to formula VIII wherein A is an isocyanate group and the further exchange reaction generally results in fluorochemical silane oligomers that have an organic residue G (formula I) which can be represented by formula IX: 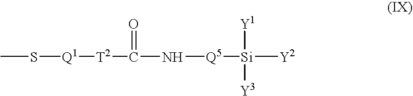
wherein Q¹ and Q⁵ each independently represents an organic divalent linking group, T² represents O or NR with R being a hydrogen or an aryl or a C₁-C₄ alkyl group, Y¹, Y² and Y³ are as defined above and at least one of Y¹, Y² and Y³ represents a hydrolysable water solubilizing group.

When a compound according to formula VIII wherein A is an epoxy group is used, the organic residue may be represented by a residue according to formula X or XI or a mixture thereof: 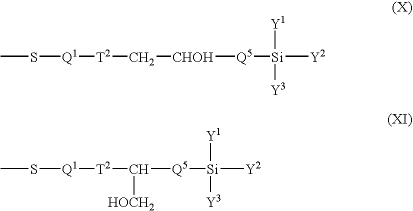
wherein Q¹, Q⁵, T² and Y¹, Y² and Y³ have the meaning as defined above in formula IX.

After preparation of the fluorochemical silane according to any of the methods described above, the fluorochemical silane may be isolated by evaporating any solvents used in the preparation.

An aqueous dispersion or emulsion of the fluorosilane can be obtained by mixing the fluorosilane in water with the aid of a surfactant. Suitable surfactants for making the emulsion or dispersion include anionic, cationic, amfoteric and non-ionic surfactants. Particular examples of surfactants that can be used include sodium dodecylbenzenesulfonate and poly(ethylene glycol) with a molecular weight of 1500. Typically the surfactant is used in an amount of 1 to 25%, preferably 3 to 6% based on the weight of fluorosilane. The emulsion or dispersion may further contain up to about 50% of a cosolvent. Suitable cosolvents for use in the aqueous composition include polar solvents and in particular water miscible organic solvents such as alcohols, ketones, ethers and acetates. Specific examples of cosolvents include methanol, ethanol, isopropanol, diethyl ether, methyl ethyl ketone and ethyl acetate. Preferably, the aqueous composition comprises less than about 30% cosolvent, more preferably less than about 10% cosolvent, and most preferably the aqueous composition is substantially free of cosolvent.

Optical Elements

The terminology “optical element” refers to a material having a particle size ranging from about 25 to 1000 micrometers and having a refractive index ranging from about 1.5 to about 2.3 and higher.

The optical elements have at least one dimension that is no larger than 2 millimeters and preferably no larger than 250 micrometers. The optical elements may be in the form of any shape such as granules, flakes and fibers. However, spheroidal glass elements, denoted as “glass beads”, “beads” and “microspheres” hereinafter are preferred for materials such as retroreflective articles (e.g., retroreflective sheetings, pavement markings and beaded projection screens).

During the manufacture of retroreflective materials, optical elements are typically fixed in place by means of a binder. Optical elements have a density or specific gravity several times that of the binder, causing the optical elements to sink into the binder layer, rather than float on the surface.

Preferred properties of optical elements will be described herein with respect to glass beads. Ordinary glass beads typically have a density of about 2.5 and a refractive index of about 1.5. “High index” beads refers to beads having a density of about 3.5 and a refractive index of about 1.9, whereas “super high index” typically refers to beads having a density of about 5 and a refractive index of about 2.3 or higher. The diameter of the glass beads typically ranges from a few micrometers to approximately 2500 micrometers and is preferably from about 25 to 1000 micrometers.

In addition to having the desired particle size and refractive index, the glass beads are typically transparent. The term transparent means that when viewed under an optical microscope (e.g., at 100×) the microspheres have the property of transmitting rays of visible light so that bodies beneath the microspheres, such as bodies of the same nature as the microspheres can be clearly seen through the microspheres, when both are immersed in oil of approximately the same refractive index as the microspheres. The outline, periphery or edges of bodies beneath the microspheres are clearly discernible. Although the oil should have a refractive index approximating that of the microspheres, it should not be so close that the microspheres seem to disappear as would be the case for a perfect match.

The optical elements may comprise microspheres that are ceramic. In general, ceramic microsphere optical elements are comprised of metal oxides that are substantially colorless. Suitable metal oxides include Al₂O₃, SiO₂, ThO₂, SnO₂, TiO₂, Y₂O₃ and ZrO₂ with the oxides of zirconium, silicon, and titanium being preferred. The ceramic microspheres can exhibit a range of properties, depending on the kind and amounts of the various metal oxides employed as well as the method of manufacture. Preferred, however, are dense microspheres having substantially no open porosity that have an average hardness greater than sand.

Additional information concerning the desired properties for various end-uses and methods of manufacture of microspheres (e.g., sol-gel process), can be found in U.S. Pat. Nos. 3,493,403, 3,709,706, and 4,564,556, incorporated herein by reference. Glass beads suitable for use as optical elements in the invention are also commercially available from Flex-O-Lite Corporation, Fenton, Mo. and Nippon Electric Glass, Osaka, Japan.

Method Of Treatment Of The Optical Elements

The optical elements are treated with the aqueous composition comprising the fluorosilane to provide a surface treatment thereto and thereby altering the floatation properties of the optical element in the binder when the latter is liquefied. “Float” and derivations thereof, described in the context of glass beads, refers to the beads assuming a position wherein slightly more than half of each bead is submerged. The binder preferably contacts the embedded beads only up to 5 to 30° above their equators. The floatability of the glass beads can be affected to some extent by the particle size, particle size distribution, surface chemistry and chemical make-up of the particular glass beads as well as the chemical make-up, density, and viscosity of the binder in its liquefied state. In general, however, only about 10% or less of the glass beads tend to float in heptane test liquid in the absence of an effective surface treatment.

The position that the glass beads attain relative to the undisturbed binder due to the surface treatment assists the anchoring of the beads in the ultimate dried or solidified binder coating. The glass beads are preferably embedded to about 40-80%, and more preferably to about 40-60% of their diameters. The beads are adequately exposed providing a sphere-lens having a large optical aperture relative to its size. During the drying or solidification of the binder, there is some shrinkage of the binder film. However, the beads remain bonded with the centers of the floated beads being approximately equidistant from the underlying back surface of the binder layer or the top surface of the base.

In addition to the improvement in floatation of the optical elements, it is also important that the surface treatment does not adversely affect the adhesion of the optical elements with the binder. The adhesion can be evaluated in several ways and will be described herein with respect to a preferred optical element, glass beads. The initial adhesion can subjectively determined by estimating the depth to which the embedded glass beads have sunk into the binder after curing. The glass beads are preferably embedded to a depth of about 40-70%, and more preferably to about 40-60% of their diameters. Another way of evaluating adhesion is accelerated aging evaluations. A piece of cured glass bead-embedded binder is conditioned in boiling water for 24 hours. After conditioning, the glass beads are preferably embedded to the same extent as prior to conditioning and the individual glass beads are difficult to remove with a dissection probe. Yet another way to evaluate the effect of the binder on adhesion is comparative tensile testing. A uniform slurry of binder and untreated glass beads at a ratio of about 1 to 3 is drawn down into a film having a thickness of about 0.4 mm. A second slurry of binder and surface treated glass beads employing the same ratio of ingredients and film thickness is prepared. After the samples are fully cured, the samples are conditioned for 24 hours in water at ambient temperature. Tensile testing is conducted with a 1″ (2.5 cm) wide sample employing a 2″ (5 cm) gap at a rate of 0.5 inches (1.3 cm)/minute. The stress at break of the sample comprising the surface treated beads is about the same as or preferably greater than the control sample, comprising untreated beads (≧about 90% of the standard deviation of the average value). Any one of the previously described methods is typically sufficient to determine whether the surface treatment adversely affects the adhesion of the glass beads with the binder. Preferably, however, all three of the evaluations are conducted.

The surface treatment should typically be present on the optical elements in an amount sufficient such that greater than about 50% of the optical elements float in heptane. Preferably, the surface treatment improves the floatability such that greater than about 80% of the optical elements float in heptane and more preferably about 90-100% of the optical elements float in heptane.

The amount of fluorosilane employed for coating the optical elements typically ranges from about 5 ppm to about 1000 ppm with respect to the weight of the optical elements. The amount of fluorosilane is usually about 600 ppm or less, preferably about 300 ppm or less, more preferably about 150 ppm, even more preferably about 100 ppm, and most preferably about 50 ppm or less. Typically, the overall coating thickness of the surface treatment of the present invention is greater than about 15 Angstroms, preferably, greater than about 20 Angstroms, and more preferably, greater than about 50 Angstroms. Thicker coatings can be obtained if desired, although it is preferred that the coating thickness be no greater than about 500 Angstroms, more preferably, no greater than about 300 Angstroms, and most preferably, no greater than about 150 Angstroms thick. Excessive concentrations of surface treatment can result in agglomeration of the optical elements. Such limits can be determined by routine experimentation and in some instances the agglomeration can be reduced by the use of flow control agents.

The surface treatment may comprise any one or any mixture of the presently described compounds as well as mixtures of the presently described surface treatment with other known surface treatments.

The optical elements may comprise one or more additional surface treatments such as adhesion promoters and flow control agents that reduce particle agglomeration. Various silanes such as 3-aminopropyltriethoxysilane are commonly employed as adhesion promoters, whereas methacrylato chromic chloride, commercially available from Zaclon Inc, Cleveland, Ohio under the trade designation “Volan” is a typical flow control agent.

Retroreflective Articles

The surface treated optical elements can be employed for producing a variety of reflective products or articles such as pavement markings, retroreflective sheeting, and beaded projection screens. Such products share the common feature of comprising a liquid binder layer and embedding a multitude of optical elements into the binder surface followed by solidifying the binder to retain the optical elements in place. In the pavement markings, retroreflective sheeting, and beaded projection screens of the invention, at least a portion of the optical elements will comprise the surface treated optical elements of the invention. Typically, the majority of, and preferably substantially all, the optical elements employed in the manufacture of the reflective products will comprise the surface treated optical elements of the invention.

Various known binder materials may be employed including various one and two-part curable binders, as well as thermoplastic binders wherein the binder attains a liquid state via heating until molten. Common binder materials include polyacrylates, methacrylates, polyolefins, polyurethanes, polyepoxide resins, phenolic resins, and polyesters. For reflective paints the binder may comprise reflective pigment. For reflective sheeting, however, the binder is typically transparent. Transparent binders are applied to a reflective base or may be applied to a release-coated support, from which after solidification of the binder, the beaded film is stripped and may subsequently be applied to a reflective base or be given a reflective coating or plating.

There are several types of retroreflective articles in which the surface treated optical elements may be used such as exposed lens (e.g., U.S. Pat. Nos. 2,326,634 and 2,354,018), embedded lens (e.g., U.S. Pat. No. 2,407,680), and encapsulated lens (e.g., U.S. Pat. No. 4,025,159) retroreflective sheeting. Retroreflective articles can be prepared by known methods including a method comprising the steps of: (i) forming a top coat on a release coated web (e.g., coating a solution of hydroxy-functional acrylic polyol and aliphatic polyfunctional isocyanate onto a release-coated paper web and then curing by conveying the coating through an oven at about 150° C. for about 10 minutes); (ii) coating the exposed surface of the top coat with a liquid binder (e.g., coating a solution comprising an oil-free synthetic polyester resin and a butylated melamine resin); (iii) drying the binder to form an uncured tacky bead-bond layer; (iv) cascade-coating onto the bead-bond layer a plurality of glass microspheres forming a monolayer of embedded glass microspheres; (v) curing the bead-containing bead-bond layer to a non-tacky state (e.g., by heating to 150° C.); forming a space coat layer over the bead-containing bead-bond layer (e.g., coating a 25% solids solution comprised of a polyvinylbutyral resin and a butylated melamine resin in a solvent and curing at 170° C. for about 10 minutes); (vi) applying a reflective layer over the space coat layer (e.g., vapor deposition of aluminum metal at a thickness of about 100 nm); and stripping away the release-coated web. An adhesive layer is typically applied to the reflective layer (e.g., by coating a 0.025 mm thick layer of an aggressive acrylic pressure-sensitive adhesive onto a silicone-treated release liner and pressing the adhesive against the reflective layer).

The surface treated optical elements are also useful in pavement marking materials. The optical elements can be incorporated into coating compositions that generally comprise a film-forming material having a multiplicity of optical elements dispersed therein. The surface treated optical elements may also be used in drop-on applications for such purposes as highway lane striping in which the optical elements are simply dropped onto wet paint or hot thermoplastic and adhered thereto.

One typical pavement marking sheet is described in U.S. Pat. No. 4,248,932. This sheet material is a prefabricated strip adapted to be laid on and secured to pavement for such purposes as lane dividing lines and comprises a base sheet, such as a soft aluminum foil which is conformable to a roadway surface; a top layer (also called the support film or binder film) adhered to one surface of the base sheet and being very flexible and resistant to rupture; and a monolayer of surface treated optical elements such as transparent microsphere lens elements partially embedded in the top layer in a scattered or randomly separated manner. The pavement marking sheet construction may also include an adhesive (e.g., pressure sensitive, heat or solvent activated, or contact adhesive) on the bottom of the base sheet. The base sheet may be made of an elastomer such as acrylonitrile-butadiene polymer, polyurethane, or neoprene rubber. The top layer in which the surface treated microspheres are embedded is typically a polymer such as vinyl polymers, polyurethanes, epoxies, and polyesters. Alternatively, the surface treated microsphere lenses may be completely embedded in a layer of the pavement marking sheet.

Pavement marking sheets may be made by processes known in the art (see e.g. U.S. Pat. No. 4,248,932), one example comprising the steps of: (i) coating onto a base sheet of soft aluminum (50 micrometers thick) a mixture of resins (e.g., epoxy and acrylonitrile butadiene elastomer mixture), pigment (TiO₂) and solvent (e.g., methyl ethyl ketone) to form the support film; (ii) dropping onto the wet surface of the support film ingredients a multiplicity of the surface treated optical elements of the invention; and curing the support film at 150° C. for about 10 minutes. A layer of adhesive is then usually coated on the bottom of the base sheet.

Pigments or other coloring agents may be included in the top layer in an amount sufficient to color the sheet material for use as a traffic control marking. Titanium dioxide will typically be used for obtaining a white color; whereas, lead chromate will typically be used to provide a yellow color.

A rear projection screen is a sheet-like optical device having a relatively thin viewing layer that is placed at an image surface of an optical projection apparatus. Rear projection screen displays comprising glass microspheres embedded in an opaque matrix are known from U.S. Pat. No. 2,378,252, for example. Generally, the size of the microspheres is less than about 150 micrometers. For maximum brightness, the microspheres have an index of refraction of less than about 1.8 and preferably from about 1.45 to about 1.75. A plurality of the surface treated glass microspheres are attached to and are in intimate contact with a major surface of a transparent substrate. Alternatively, a diffusion layer can be formed by coating an optically inhomogeneous material as a separate layer onto the transparent substrate prior to application of the opaque binder and microspheres. Rear projection screens are prepared by i) providing a substrate (e.g., polyester, polycarbonate) having an opaque binder disposed thereon (e.g., acrylate loaded with carbon black to make it opaque); and ii) applying the surface treated glass microspheres under conditions effective to produce microspheres in optical contact with the substrate and embedded in the opaque matrix.

In some useful embodiments of the invention, a specular reflective means is provided by a layer of metal (e.g., aluminum) vapor-deposited on the surface treated microspheres. Another useful specular reflective means is a dielectric reflector which comprises one or more layers of a transparent material behind the microspheres, each layer having a refractive index of about 0.3 higher or lower than that of the adjacent layer or beads and each layer having an optical thickness corresponding to an odd numbered multiple of about ¼ wavelength of light in the visible range. More detail on such dielectric reflectors is found in U.S. Pat. No. 3,700,305.

The invention is further illustrated by the following examples.

### EXAMPLES

Preparation of the Fluorochemicals and Formulations

In this application the following abbreviations are used:

“MeFBSEA” is N-methyl-perfluorobutanesulfonylethyl acrylate which was prepared according to the procedure described in Example 2B of International PCT Publication WO 01/30873 (Savu et al).

“MeFBSPTMS” is N-methyl-perfluorobuanesulfonylpropyl trimethoxysilane was prepared using the same procedure found in Example 6 of U.S. Pat. No. 5,274,159 but using the N-methyl perfluorobutanesulfonyl analog.

“ODA” is octadecyl acrylate which is available from Aldrich Chemical.

“A-174” is 3-(trimethoxysilyl)propyl methacrylate and is available from Aldrich Chemical.

“VAZO 64” is a free radical initiator available from Dupont, Wilmington, Del.

“PEG-1500” is poly(ethylene glycol) with a molecular weight of 1,500 and is available from Aldrich Chemical.

“DS-10” is sodium dodecylbenzenesulfonate available from Rhone-Poulenc, Princeton, N.J. under the trade designation SIPONATE DS-10.

“FP-1” is an oligomer obtained from MeFBSEA and (3-mercaptopropyl)trimethoxysilane (molar ratio 4:1).

“FP-2” is an oligomer obtained from MeFBSEA and (3-mercaptopropyl)trimethoxysilane (molar ratio 6:1).

“FP-3” is an oligomer obtained from MeFBSEA, ODA, and (3-mercaptopropyl)trimethoxysilane (molar ratio 4:0.3:1).

“FP-4” is an oligomer obtained from MeFBSEA, ODA and (3-mercaptopropyl)trimethoxysilane (molar ratio 4:0.6:1).

“FP-5” is an oligomer obtained from MeFBSEA, ODA, A-174 and 2,2-(dihydroxymethyl)butyl tris(3-mercaptopropionate) (molar ratio 5:1:1:1).

“FP-6” is an oligomer obtained from MeFBSEA, ODA, A-174 and HSC₂H₄OCH₂)₂ (molar ratio 6:1:0.5:1).

“FP-7” is an oligomer obtained from 3,3,4,4,5,5,6,6,7,7,8,8,8-tridecafluorooctyl acrylate and 3-(triethoxysilyl)propylamido 3-mercaptopropionate (molar ratio 1:1).

“FP-8” is an oligomer obtained from MeFBSEA, A-174, and stearyl 3-mercaptopropionate (molar ratio 6:1:1).

All other chemicals used in the examples are available from Aldrich Chemical (Milwaukee, Wis.) except for 3-mercaptopropionic acid octadecyl ester which is available from Dow Chemical Co. (Midland, Mich.).

### Comparative Example 1

### Emulsification of MeFBSPTMS

A 1% solution of DS-10 in water was made by dissolving one part DS-10 in 99 parts distilled water. This solution was stirred at room temperature until the DS-10 dissolved. Then 3% MeFBSPTMS was added. The solution was stirred for an additional 30 minutes but was observed to have an oily phase and an aqueous phase after this time. The mixture slowly develop a white precipitate on standing over a period of one week.

### Example 1

### Preparation of FP-1 Solution and Emulsion

80 mmoles MeFBSEA (32.88 g), 20 mmoles 3-(trimethoxysilyl)propyl mercaptan (3.92 g), ethanol (40 g) and ethyl acetate (20 g) were placed in a bottle that was flushed thoroughly with N₂. VAZO 64 (0.1 g) was added and N₂ was bubbled through the mixture to remove oxygen, the bottle was sealed, and the mixture was polymerized at 70° C. for 24 hours. The resulting polymer solution (FP-1S) with 38% solids was analyzed by FTIR, which confirmed the disappearance of the acrylate double bond signal (1637-1621 cm⁻¹).

50 g of the above polymer solution was emulsified with DS-10 (0.75 g) in water (100 g). Solvent was stripped in vacuo to yield 106 g of an emulsion (FP-1E) having 18.5% solids content.

### Example 2

### Preparation of FP-2 Emulsion

120 mmoles MeFBSEA (49.32 g), 20 mmoles 3-(trimethoxysilyl)propyl mercaptan (3.92 g), ethyl acetate (100 g), and VAZO 64 (0.5 g) were polymerized in a procedure identical to that described in Example 1. A solution of 34% solids was obtained.

The polymer solution was emulsified with DS-10, (1.6 g) and PEG-1500 (10.64 g) in water (200 g). 250 g of an emulsion (FP-2E) with 25.2% solids was obtained after solvent stripping.

### Example 3

### Preparation of FP-3 Solution and Emulsion

160 mmol MeFBSEA (65.76 g), 11.3 mmol ODA (3.80 g), 40 mmol 3-(trimethoxysilyl)propyl mercaptan (7.84 g), ethyl acetate (106 g), isopropanol (14 g) and VAZO 64 (0.2 g) were placed into a bottle and polymerized at 70° C. for 24 hours using a procedure identical to that described in Example 1. The obtained polymer solution (FP-3S) was 39.21% solid and was analyzed by FTIR.

The polymer solution was emulsified with sodium dodecylbenzenesulfonate (DS-10, 1.9 g) and PEG-1500 (20 g) in water (250 g). An emulsion (FP-3E) with 18.3% solids was obtained after solvent stripping.

### Example 4

### Preparation of FP-4 Emulsion

200 mmoles MeFBSEA (82.20 g), 30 mmoles ODA (9.75 g), 50 mmoles 3-(trimethoxysilyl)propyl mercaptan (9.80 g), VAZO 64 (1.1 g), and ethyl acetate (200 g), were polymerized at 70° C. for 24 hours using a procedure identical to that described in Example 1. A solution with 39.2% solids was obtained.

The polymer solution was emulsified with DS-10 (2.0 g) and PEG-1500 (15 g) in water (400 g). An emulsion (FP-4E) with 22.4% solids was obtained after solvent stripping.

### Example 5

### Preparation of FP-5 Emulsion

240 mmoles MeFBSEA (98.64 g), 40 mmoles ODA (13.0 g), 40 mmoles—(trimethoxysilyl)propyl mercaptan (9.92 g), 40 mmoles 2,2-(dihydroxymethyl)butyl tris(3-mercaptopropionate) (15.94 g), VAZO 64 (1.0 g), and ethyl acetate (220 g) were polymerized at 70° C. for 15 hours in a manner similar to that described in Example 1. The obtained solution was 38% solids.

The solution was emulsified with DS-10 (4.0 g) and PEG-1500 (20 g) in water (600 g). The resulting emulsion (FP-5E)) had 18% solids after solvent stripping.

### Example 6

### Preparation of FP-6 Emulsion

300 mmoles MeFBSEA (123.3 g), 50 mmoles ODA (16.25 g), 25 mmoles, 3-(trimethoxysilyl)propyl mercaptan (6.20 g), 50 mmoles 3,6-dioxa-1,8-octanedithiol (9.10 g), VAZO 64 (1.1 g), and ethyl acetate (250 g) were polymerized at 70° C. for 4 hours in a manner similar to that described in Example 1. Additional VAZO 64 (0.2 g) was added and the solution was heated to 70° C. for another 10 hours. The obtained solution was 38% solids.

300 g of the above solution was emulsified with DS-10 (3.3 g) and PEG-1500 (20 g) in water (500 g). The resulting emulsion (FP-6E) had 18.7% solids after solvent stripping.

### Example 7

### Preparation of FP-7

40 mmoles 3,3,4,4,5,5,6,6,7,7,8,8,8-tridecafluorooctyl acrylate (16.72 g), 10 mmoles 2-mercaptoethanol (0.78 g), VAZO 64 (0.175 g), and ethyl acetate (32.5 g) were polymerized at 70° C. for 24 hours in a manner similar to that described in Example 1. The obtained solution (50 g) was 35% solids.

29.4 g of the solution was reacted with 1.46 g 3-(trimethoxysilyl)propylisocyanate in 40 g ethyl acetate with 5 drops of dibutyltin dilaurate catalyst at 70° C. for 4 hours. The resulting solution of FP-7 had 22.7% solids and showed no isocyanate peak in the FTIR.

### Example 8

### Preparation of FP-8

240 mmoles MeFBSEA (98.64 g), 40 mmoles 3-(trimethoxysilyl)propyl mercaptan (9.92 g), 40 mmoles 3-mercaptopropionic acid octadecyl ester (14.0 g), VAZO 64 (0.5 g), and ethyl acetate (200 g) were polymerized at 70° C. for 24 hours in a manner similar to that described in Example 1. The obtained solution was 38% solids.

Stability of Aqueous Formulations with Fluorooligomers

TABLE I
Stability of Emulsions with Fluorooligomers

| Sample | Formulation | Stability (Time to Gel) |
|---|---|---|
| MeFBSPTMS | water emulsion as described | 1 week |
| | in Comparative Example 1 | |
| FP-1E | water emulsion (Example 1) | >30 months |
| FP-2E | water emulsion (Example 2) | >30 months |
| FP-3E | water emulsion (Example 3) | >30 months |
| FP-4E | water emulsion (Example 4) | >30 months |
| FP-5E | water emulsion (Example 5) | >30 months |
| FP-6E | water emulsion (Example 6) | >30 months |

Glass Bead Flotation Test

### Examples 9-20

### Application for Glass Bead Flotation

Spherical glass beads (71 micrometer average diameter, described as Type I beads in U.S. Publication No. 2002/0090515 (Jing et al)) were treated with fluorooligomers FP-1 to FP-8 as follows: The fluorooligomer (FP-1 to FP-8) was diluted with the indicated solvent from Table II to obtain the desired concentration based on solids content. The fluorooligomer employed, the solvent system used, the theoretical concentration of fluorooligomer on Type I bead, and % of the beads floating are reported in Table II. The procedure used to surface treat and test the floatation of the beads was identical to that described in the example section of U.S. Publication No. 2002/0090515, cited above.

Flotation tests were carried out using a heptane flotation test as follows: A single layer of optical elements (treated beads) was spread on a clean inverted pint paint can lid. Heptane was slowly introduced with a syringe or dropper at the edge of the lid until it overflowed. The percentage of optical elements floating was visually estimated. The beads were tested within 24 hours of being coated with the copolymer surface treatment. The results are shown in Table II.

TABLE II
Percentage of Floating Glass Beads After Treatment With Copolymers

| | | | Treatment | Flotation |
|---|---|---|---|---|
| Example | Copolymer | Solvent | Level (ppm) | (%) |
| 9 | FP-1S | ethyl acetate | 200 | 100 |
| 10 | FP-1E | water | 150 | 100 |
| | | emulsion | | |
| 11 | FP-2E | water | 150 | 100 |
| | | emulsion | | |
| Comparative | FP-3S | ethyl acetate | 200 | 45* |
| Example 2 | | | | |
| 12 | FP-3S | ethyl acetate | 200 | 100** |
| 13 | FP-3E | water | 200 | 100 |
| | | emulsion | | |
| 14 | FP-4E | water | 150 | 100 |
| | | emulsion | | |
| 15 | FP-5E | water | 150 | 100 |
| | | emulsion | | |
| 16 | FP-6E | water | 150 | 100 |
| | | emulsion | | |
| 17 | FP-7 | ethyl acetate | 200 | 100 |
| 18 | FP-8 | isopropanol | 200 | 50% |
| 19 | FP-8 | isopropanol | 400 | 100% |

*dried ethyl acetate added for dilution
**a drop of water was added to the solution of Comparative Example 1

In all examples except Comparative Example 2 the solvent was not dried prior to use. In Comparative Example 2, dried ethyl acetate was used as the bead treatment solvent. The results indicate that a small amount of residual water in the solvents is needed to hydrolyze the siloxane ester groups of the fluorooligomers before they can adhere to the beads. A drop of water was added to the fluorooligomer solution of Comparative Example 2 to treat the beads in Example 12.

1. Aqueous composition comprising a surfactant and a fluorosilane according to the general formula:
X-M^{f}ₙM^{h}ₘM^{a}ᵣ-G (I)
wherein X represents the residue of an initiator or hydrogen;
M^{f} represents units derived from one or more fluorinated monomer;
M^{h} represents units derived from one or more non-fluorinated monomer;
M^{a} represents units having a silyl group represented by the formula: 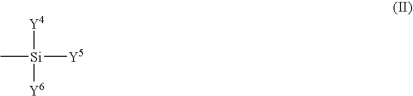
wherein each of Y⁴, Y⁵ and Y⁶ independently represents an alkyl group, an aryl group and at least one of Y⁴, Y⁵ and Y⁶ represents a hydrolyzable group selected from the group consisting of halogens, alkoxy groups, acyloxy groups, acyl groups and aryloxy groups;
G is a monovalent organic group comprising the residue of a chain transfer agent;
n represents a value of 1 to 100;
m represents a value of 0 to 100;
and r represents a value of 0 to 100;
and n+m+r is at least 2;
with the proviso that at least one of the following conditions is fulfilled: (a) G contains a silyl group of the formula: 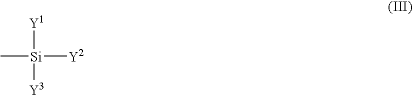
wherein Y¹, Y² and Y³ each independently represents an alkyl group, an aryl group or a hydrolyzable group and at least one of Y¹, Y² and Y³ represents a hydrolyzable group selected from the group consisting of halogens, alkoxy groups, acyloxy groups, acyl groups and aryloxy groups; or (b) r is at least 1.

2. Aqueous composition according to claim 1 wherein the composition further comprises a co-solvent in an amount of up to 50% by weight of the total weight of the composition.

3. Aqueous composition according to claim 2 wherein the co-solvent is selected from the group consisting of alcohols, ketones, ethers and acetates.

4. Aqueous composition according to claim 1 wherein the composition wherein the fluorinated monomer corresponds to the formula:
R_{f}-Q-E¹
wherein R_{f} represents a fluoroaliphatic group comprising at least 3 carbon atoms, Q represents an organic divalent linking group and E¹ represents a free radical polymerizable group.

5. Aqueous composition according to claim 4 wherein R_{f} represents C₄F₉—.

6. Aqueous composition according to claim 1 wherein said unit M^{a} is derivable from a monomer represented by the formula: 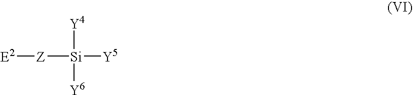
wherein Y⁴,Y⁵ and Y⁶ have a meaning as defined in claim 1, Z represents an organic divalent linking group and E² represents a free radical polymerizable group.

7. Method of treating an optical element comprising contacting an aqueous composition according to claim 1.

8. Method of treating an optical element according to claim 7 wherein said optical element comprises glass or ceramic microspheres.

9. A surface treated optical element obtainable according to the method of claim 7.

10. A liquid composition comprising surface treated optical elements according to claim 9.

11. A retroreflective article comprising surface treated optical elements according to claim 9.

12. A rear projection screen comprising a transparent substrate and a multitude of optical elements according to claim 9 embedded in an opaque binder matrix and wherein said optical elements are in contact with the transparent substrate.
